(19) United States
(12) Patent Application Publication
(10) Pub. No.: US 2013/0091231 A1
(43) Pub. Date: Apr. 11, 2013

(54) SIMPLE MESSAGE DELIVERY DEVICE WITH INTERNET FUNCTION

(71) Applicant: ICAM TECHNOLOGIES CO., LTD., TAIPEI CITY (TW)

(72) Inventors: SHAN-LIN CHOU, TAIPEI CITY (TW); YI-HSIN CHEN, TAIPEI CITY (TW); CHIN-DE LIU, NEW TAIPEI CITY (TW)

(73) Assignee: ICAM TECHNOLOGIES CO., LTD., TAIPEI CITY (TW)

(21) Appl. No.: 13/645,615

(22) Filed: Oct. 5, 2012

(30) Foreign Application Priority Data
Oct. 7, 2011 (TW) 100136609

(51) Int. Cl. G06F 15/16

(52) U.S. Cl. 709/206

(57) ABSTRACT

A simple message delivering device with internet function is revealed. The device has a simple message module electrically connected with one or more peripheral devices and a server, and receives warning signals corresponding to a status information and a connection information from the peripheral devices through an I/O unit, in which the connection information of the peripheral device is related to locations of the peripheral devices for a NAT unit obtaining a LAN network address of one of the peripheral devices and an internet network address of a simple message module. A message unit generates a simple message according to the LAN network address, the internet network address and the status information to output to a server for delivering the simple message to an electronic device. Thus, the present invention prevents the peripheral device having no network reporting from the retirement, and it further reduces the arrangement cost.

### FIELD OF THE INVENTION

The present invention relates generally to an information device, and particularly to a simple message delivering device with internet function.

### BACKGROUND OF THE INVENTION

In the century that science and technology are developed rapidly, monitoring systems have been become a part of life security of modern people. Each of the monitoring systems usually monitors a plurality of area by continuously taking a lot of images via a plurality of video cameras (CAMs), and a digital video recorder (DVR) is used to receive the captured images from the CAMs. Recently, a digital monitoring system processes compressed/decompressed operations of images using an image codec chip, so the DVR can access the captured images from the CAMs for extending the recording time and solving a signal attenuation problem or a quality-down problem of the conventional Video tape recorder (VTR). Furthermore, people can use the DVR to play the captured images from the digital CAMs. People also can search and read one of the captured images access by the DVR via several recordation parameters, which are date, time, camera serial number, warning recordation and so on, because the DVR accesses the captured images through the recordation parameters.

Although a security host and a monitoring device can provide a security protection for a residing place or a working place. However, generally, the security host is needed to set and fix on a specific location of a building. Thereby, people must ahead to the location, where is set the security host, for executing search of the captured images or settings of the security host. In the contrast, said operation manner is very inconvenient to a resident living in a building with multiple floors or a occupied wide place. In particular to a community building, it is further inconvenient to a resident living on a higher floor. Then, a wireless remote controller system is revealed for solving said above problem of the security host. The wireless remote control system is connected with the security host via a wireless network. An input unit generates a start-up signal according to an external operation behavior. A remote processing system converts the start-up signal into a request signal, and the request signal is transferred to the security host through a wireless remote communicating unit. Thereby, the wireless remote controller system is synchronized and connected with the security host for providing people to use the wireless remote control system and to check an option window of the wireless remote control system via an system option menu for controlling the synchronization.

Besides, with mature development of network communication system, it is further submitted that a remote control device obtains the monitoring of the residing place or the working place. The transmission of video messages is further executed through the network communication system for caring families' situations of the daily routine. Therefore, user can dispose a network monitoring device in home, such as IP CAM, the IP CAM can connect with an internet directly to communicate with a computer device under used. People not in home can use another computer device with network communication or a cell phone with network communication to connect with a predetermined network address through the internet due to the IP CAM having the specific network address. That is, people can obtain the video messages or the voice messages from remote terminal, in which the video messages and the voice messages are captured by the IP CAM.

However, above remote connection mechanism is based on a requirement that people have a certain degree of knowledge related to a network communication mechanism, but general people fail to understand the knowledge related to the network communication mechanism. Furthermore, each residing place or each working place fails to have only one monitoring device, and people use computer devices to connect with all IP CAM in any time. As well, IP CAMs are communicated with the computer devices via the internet for outputting the captured images to the computer devices. Thereby, the network resource is consumed very much. Also, not all of the security hosts can be connected with the internet, so people only identify the condition via survey of the captured images, and it wastes time very much and is not easy to obtain the status information of the warning from the security host while the security host cannot be connected with the internet.

Regarding above problems, a simple message delivering device with internet function is revealed. The device improves the problem of the conventional monitoring devices failing to connect with the internet, so the device can provide all peripheral devices of the security protection device being able to report warning via the internet. People can use the computer or the cell phone to connect with the security host or the peripheral device thereof easily without complicated settings.

### SUMMARY

An objective of the present invention is to provide a simple message delivering device with internet function, which provides a convenience for improving warning report to provide all warning notification mechanisms without network connection for being able to work within network to eliminate the replacement.

Another objective of the present invention is to provide a simple message delivering device with internet function, which provides a convenient remote connection with complicated settings.

A simple message delivering device with internet function is revealed. The device comprises a simple message module coupled to one or more peripheral devices and a server. The simple message module comprises an input/output (I/O) unit, a detection part, a searching part, a Network Address Translation (NAT) unit, a message unit and a connection unit. The I/O unit is electrically connected with the searching part and said peripheral devices. The NAT unit is electrically connected with the searching part and the peripheral devices. The message unit is coupled to the NAT unit and the searching part. The connection unit is electrically connected with the message unit. The I/O unit receives a warning signal from the peripheral device, in which the warning signal is corresponding to a status information and a connection information of the peripheral devices, and the connection information is related to a location of one of the peripheral devices. The NAT unit obtains a local network (LAN) address of one of the peripheral devices according to the status information and the connection information, and the NAT unit also obtains an internet IP of one of the simple message module according to the status information and the connection information. The message unit generates a simple message according to the LAN network address of the peripheral device, the internet network address of the simple message module and the status information, and the message unit connects a server via the connection unit for delivering the simple message to an electronic device. Hence, people do not need to throw away the peripheral devices without network reporting function, and people also do not need to proceed complicated settings for remote connection. Accordingly, the present invention can make people use the electronic device directly connecting with the simple message delivering device or the peripheral devices through the internet according to the simple message.

### BRIEF DESCRIPTION OF THE DRAWINGS

FIG. 1 shows a schematic diagram of a power supply according to an embodiment of the present invention;

FIG. 2 shows a schematic diagram according to another embodiment of the present invention; and

FIG. 3 shows a flowchart according to an embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

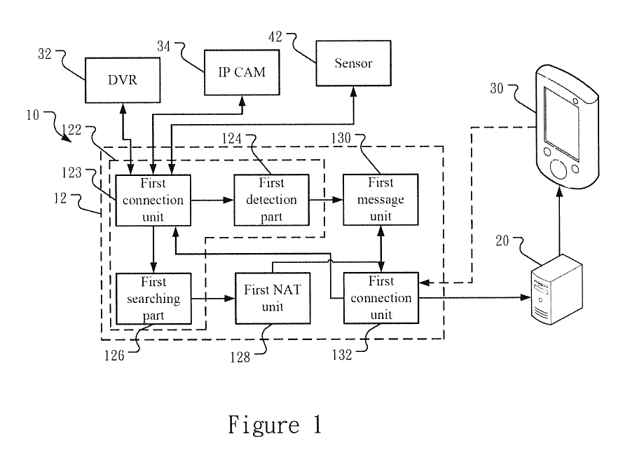

FIG. 1 shows a schematic diagram of a power supply according to an embodiment of the present invention. As shown in figure, the simple message delivering device with internet function 10 comprises a first simple message module 12 comprising a first I/O unit 122, a first NAT unit 128, a first message unit 130 and a first connection unit 132. Furthermore, the first I/O unit 122 further comprises a first connection part 123, a first detection part 124 and a first searching part 126.

One or more ports are disposed on the first connection part 123 of the first I/O unit 122 to connect external peripheral devices, such as DVR 32, IP CAM 34 and sensor 42 in this embodiment. The ports supported by the first I/O unit 122 comprise RS232 port, RS485 port, analog port and digital port. As well, the sensor 42 in the embodiment is a fire sensor as example, but the sensor 42 of the invention is not limited to the fire sensor, the sensor 42 also can be an anti-theft sensor or an emergency shelter sensor. The first detection part 124 is electrically connected with the first connection part 123 and detects a status of the connected peripheral device according to the received input signal of the first I/O unit 122 to obtain a status information of the connected peripheral device, such as the status information generated from the DVR 32 or IP CAM 34. The first searching part 126 is electrically connected with the first connection part 123 and detects the used network channel of the connected peripheral device according to the received input signal of the first I/O unit 122 to search the connected peripheral device through a universal Plug & Play (UPnP) protocol, such as searching DVR 32 within a network port 200.

Continuously, the first NAT unit 128 is electrically connected with the first searching part 126 and obtains a corresponding network address in accordance with the connection information generated from the first searching part 126. The corresponding network address is used for remote connection. That is, the first NAT unit 128 generates a LAN network address of the connected peripheral device according to a NAT protocol, and also captures an internet network address of the first simple message module 12. The first message unit 130 is electrically connected with the first searching part 124 and the first NAT unit 128 to receive the status information from the first searching part 124 and the LAN network address of the connected peripheral device and the internet network address of the first simple message module 12. In the meanwhile, the first message unit 130 generates a simple message according to the received status information, the internet network address and the LAN network address. Besides, the first message unit 130 records the transmission course of the warning signal from the connected peripheral device. The first connection unit 132 is electrically connected the first message unit 130 and the first NAT unit 128 and transmits the simple message from the first message unit 130 to the server 20 for delivering the generated simple message to the electronic device 30.

The server 20 in the embodiment is set in a telecommunications company or a simple message service center, and the server is also able to be a self-arranged server. On the other hands, the server 20 delivers the generated simple message to the electronic device 30 according to a simple message service (SMS) protocol. Furthermore, the server 20 further can be a mail server for delivering the generated simple message to the electronic device 30 according to a push mail protocol. That is to say, the electronic device 30 is a client terminal device with a continuous connection. Additionally, a connection of the electronic device 30 in the embodiment is preset in the first connection unit 132 of the first simple message module 12, so the first connection unit 132 transmits the generated simple message to the electronic device 30 each time of the message transmission. As well, the simple message generated from the first message unit 130 has the corresponding status information and the LAN network address and the internet network address. Thereby, user further can use the electronic device 30 to connect with the simple message module 12 or the connected peripheral device, such as the DVR 32 and the IP CAM 34.

For example, the DVR 32, the IP CAM 34 and the sensor 42 are disposed in the network ports 200 and 600 and are connected with the first I/O unit 122, and the DVR 32 and the IP CAM 34 have LAN network addresses which are 192.168.1.5 and 192.168.1.6 respectively. The internet network address of the first simple message module 12 is an external Network address which are 165.111.192.111. However, the sensor 142 has no LAN network address, so the first searching part 126 cannot obtain the network port of the sensor 42. Thus, the first NAT unit 128 indicates the LAN network address of the sensor 42 mapping the first simple message module 12. Further, the first searching part 126 can detect the network ports 200 and 600 of the DVR 32 and the IP CAM 34, respectively. Thus, the first NAT unit 128 indicates the network address of the DVR 32 and the IP CAM 34 to be 165.111.192.111:200 and 165.111.192.111:600.

As carrying on the above, when the sensor 42 senses a fire, a fire warning signal is generated to the first I/O unit 122. Thereby, the first detection part 124 generates a fire warning status information in response to the fire warning signal. The first searching part 126 obtains the connection information which is “0”, and then the first NAT unit 128 indicates the network address mapping the network address of the first simple message module 12, in which the indicated network address is 165.111.192.111. The first message unit 130 generates a corresponding fire simple message in response to the fire warning status information and the network address “165.111.192.111.” The first connection unit 132 receives the corresponding fire simple message from the first message unit 130 and delivers the corresponding fire simple message to the electronic device 30 via the server 20. When the IP CAM 34 detects an exception, an exceptional warning signal is generated to the first I/O unit 122. Thereby, the first detection part 124 generates an exceptional warning status information in response to the exceptional warning signal. The first searching part 126 obtains the connection information which is “600”, and then the first NAT unit 128 indicates the network address mapping the network address of the first simple message module 12, in which the indicated network address is 165.111.192.111:600. The first message unit 130 generates a corresponding exception simple message in response to the exceptional warning status information and the network address “165.111.192.111:600.” The first connection unit 132 receives the corresponding exception simple message from the first message unit 130 and delivers the corresponding exception simple message to the electronic device 30 via the server 20. Therefore, user can use the electronic device 30 to connect the network address “165.111.192.111:600” for connecting with the IP CAM 34. Thus, the present invention can provide people for receiving the simple message into the electronic device 30 to obtain the status of the residing place or the working place. It further can provide people can use the electronic device 30 connect to the first simple message module 12 or the connected peripheral device, such as the DVR 32 and the IP CAM 34.

Besides, at least one of the first I/O unit 122, the first NAT unit 128, the first message unit 130 and the first connection unit 132 of the first simple message module 12 is integrated into a Programmable Logic Controller (PLC). Further, the present invention can support the sensors or the IP CAMs having no network connection function, thereby, the sensors or the IP CAMs having no network connection function can report the status and the monitoring result to the electronic device 30 via the simple message delivering manner according to the present invention. It will prevent the sensors or the IP CAMs having no network connection function from the retirement, and will prevent the arrangement cost from wasting.

Also, the electronic device 30 in the embodiment is a smart phone, but the invention is not limited to the smart phone. The electronic device 30 further can be a tablet computer, a general cell phone, a desktop computer and a notebook computer. It provides people for connecting to the first simple message module 12 or the connected peripheral device, such as the DVR 32 or the IP CAM 34.

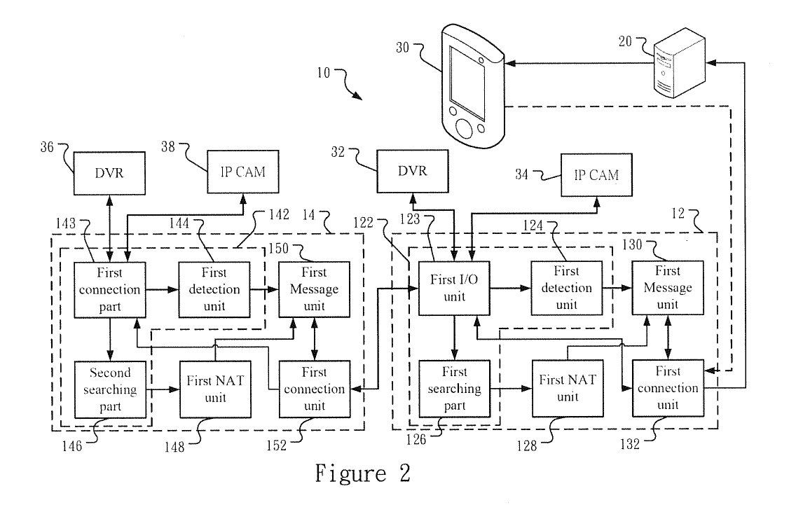

FIG. 2 shows a schematic diagram according to another embodiment of the present invention. The difference between the FIG. 1 and the FIG. 2 is the FIG. 1 only showing the first simple message module 12 connecting with the peripheral devices and the FIG. 2 further showing a plurality of simple message modules connecting with the peripheral devices. As shown in the figure, the simple message delivering device with internet function 10 comprises a first simple message module 12 and a second simple message module 14. The first simple message module 12 comprises a first I/O unit 122, a first NAT unit 128, a first message unit 130 and a first connection unit 132. Furthermore, the first I/O unit 122 further comprises a first connection part 123, a first detection part 124 and a first searching part 126. The second simple message module 14 comprises a second I/O unit 142, a second NAT unit 148, a second message unit 150 and a second connection unit 152. Furthermore, the second I/O unit 142 further comprises a second connection part 143, a second detection part 144 and a second searching part 146. Due to the first simple message module 12 is the same as the first simple message module 12 shown in the foregoing embodiment, the relationship of the first simple message module 12 will not be repeated again. Further, the second I/O unit 142, the second connection part 143, the second detection part 144, the second searching part 146, the second NAT unit 148, the second message unit 150 and the second connection unit 152 are the same as the first I/O unit 122, the first connection part 123, the first detection part 124, the first searching part 126, the first NAT unit 128, the first message unit 130 and the first connection unit 132, respectively. Thereby, the relationship of the second I/O unit 142, the second connection part 143, the second detection part 144, the second searching part 146, the second NAT unit 148, the second message unit 150 and the second connection unit 152 will not be repeated again. The first connection part 123 is connected with the DVR 32 and the IP CAM 34, and the second connection part 143 is connected with the DVR 36 and the IP CAM 38.

The second connection unit 152 is electrically connected with the first I/O unit 122 of the first simple message module 12, thereby, the generated simple message from the second message unit 150 is delivered to the first I/O unit 122. Further, the simple message from the second message unit 150 will be delivered from the first I/O unit 122 to the first connection unit 132 directly. That is, the simple message from the second message unit 150 will be delivered through the transmission path between the first I/O unit 122 and the first connection unit 132, as shown in the FIG. 2. Besides, at least one of the second I/O unit 142, the second NAT unit 148, the second message unit 150 and the second connection unit 152 of the second simple message module 14 is integrated into a Programmable Logic Controller (PLC).

According to above, the first simple message module 12 further can connect to other simple message module through the first I/O unit 122 to expand the hardware apparatus and to further reduce operation loading of signal process in signal simple message module for up to the performance.

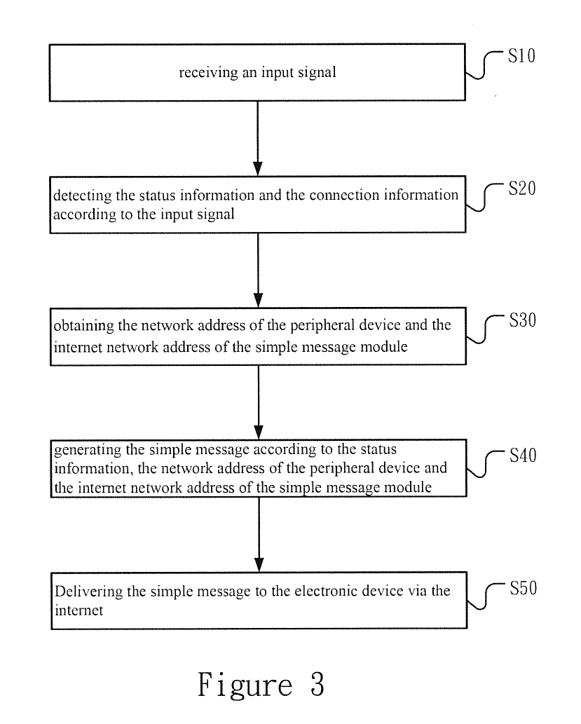

FIG. 3 shows a flowchart according to an embodiment of the present invention. As shown in figure, the flow for generating the simple message of the simple message delivering device according to the present invention comprising the step of:

Step S10: receiving an input signal;

Step S20: detecting the status information and the connection information according to the input signal;

Step S30: obtaining the network address of the peripheral device and the internet network address of the simple message module;

Step S40: generating the simple message according to the status information, the network address of the peripheral device and the internet network address of the simple message module; and

Step S50: delivering the simple message to the electronic device via the internet.

As proceeded in step S10, the simple message module receives an input signal from a peripheral device through an I/O unit, that is, the simple message module receives a warning signal from the peripheral device. As to step S20, a detection part and a searching part of the I/O unit obtains the status information and the connection information of the peripheral device in response to the input signal. The connection information is corresponding to the location and the LAN information. At step 30, the NAT unit of the simple message module obtains the corresponding Network address according to the connection information and the location. When the peripheral device has a LAN network address, the NAT unit indicates the external connection to the peripheral device according to the connection information for indicating the connection port of the simple message module, in which the connection port is used for network connection. In the same time, the NAT unit captures the internet network address of the simple message module. While step S40 is processed, the simple message module generates a simple message according to the status information obtained in step S20 and the network address of the peripheral device and the internet network address obtained in step S30, for reading in the electronic device. As executed in step S50, the simple message module delivers the simple message generated in step S50 to the electronic device via the server. It provides users for obtaining the current status information of the residing place or the working place through directly reading the simple message. It further provides the electronic device for directly connecting with the simple message module via the internet according to the network address in the simple message.

To sum up, a simple message delivering device with internet function according to the present invention, which comprises an I/O unit receiving an input signal from one of the peripheral devices for detecting the status information and connection information of the peripheral device. A NAT unit generates corresponding network address according to the connection information for generating a simple message in a message unit in accordance with the network address. Also, the electronic device user can read the simple message to obtain the status of the residing place or the working place in an outdoor place. The user further can use the electronic device to connect the simple message module or the peripheral device according to the network address for obtaining the actual status.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature or spirit described in the claims of the present invention are included in the appended claims of the present invention.

1. A simple message delivering device with internet function, which comprising:
a first simple message module, electrically connected with a first peripheral device and a server, the server communicated with an electronic device, the first simple message module comprising:
a first input and output (I/O) unit, receiving a first warning signal from the first peripheral device, the first warning signal corresponding to a first status information and a first connection information, the first connection information related to a location of the first peripheral device; and
a first network address translation (NAT) unit, electrically connected with the first peripheral device, obtaining a first network address of the first peripheral device according to the first connection information and the location, also capturing an internet network address of the first simple message module;
a first message unit, electrically connected with the first NAT unit and the first I/O unit, generating a first simple message according to the first network address, the internet network address and the first status information; and
a first connection unit, electrically connected with the first message unit, the first connection unit connected with the server, the first connection unit receiving the first simple message and outputting to the server for delivering the first simple message to the electronic device.

2. The device as claimed in claim 1, wherein the server delivers the simple message to the electronic device according to a simple message service protocol.

3. The device as claimed in claim 1, wherein the server delivers the simple message to the electronic device according to a push mail protocol.

4. The device as claimed in claim 1, wherein the first NAT unit obtains the first network address according to a NAT protocol.

5. The device as claimed in claim 4, wherein the electronic device is further connected with the first connection unit via an interne according to the first network address to be further connected with the first message unit for downloading the status information.

6. The device as claimed in claim 1, wherein the electronic device is connected with the first simple message module via an internet according to the first network address for connecting with the first peripheral device.

7. The device as claimed in claim 1, further comprising:
a second simple message module, electrically connected with a second peripheral device, the second simple message module comprising:
a second I/O unit, electrically connected with second peripheral device to receive a second warning signal from the second peripheral device, the second warning signal corresponding to a second status information and a second connection information, the second connection information related to a location of the second peripheral device; and
a second network address translation (NAT) unit, electrically connected with the second peripheral device, obtaining a second network address of the second peripheral device according to the second connection information and the location, also capturing the internet network address;
a second message unit, electrically connected with the second NAT unit and the second I/O unit, generating a second simple message according to the second network address, the interne network address and the second status information; and
a second connection unit, electrically connected with the second message unit and first I/O unit, the first simple message module receiving the second simple message and outputting to the server for delivering the second simple message to the electronic device.

8. The device as claimed in claim 7, wherein at least one of the second I/O unit, the second NAT unit and the second message unit is integrated into a Programmable Logic Controller (PLC).

9. The device as claimed in claim 1, wherein the first connection unit is connected with the server through an internet.

10. The device as claimed in claim 1, wherein the first peripheral device is a Digital Video Recorder (DVR), a IP CAM or a sensor.

11. The device as claimed in claim 1, wherein at least one of the first I/O unit, the first NAT unit and the first message unit is integrated into a Programmable Logic Controller (PLC).
